(19) United States
(12) Patent Application Publication
(10) Pub. No.: US 2006/0163010 A1
(43) Pub. Date: Jul. 27, 2006

(54) Self-centering device for compensation ropes or chains of an elevator

(76) Inventor: Mario Ogava, Sao Paoulo (BR)

Correspondence Address: SCHWEITZER CORNMAN GROSS & BONDELL LLP, 292 MADISON AVENUE - 19th FLOOR, NEW YORK, NY, 10017, US

(21) Appl. No.: 11/137,898

(22) Filed: May 26, 2005

(30) Foreign Application Priority Data
Jul. 28, 2004 (EP) EP 04405330.4

(51) Int. Cl. B66B 11/02

(52) U.S. Cl. 187/401

(57) ABSTRACT

An elevator comprises a cabin with a cabin floor and at least a compensation chain or rope being connected by a fixation point to the cabin floor. A displacement element is provided between the cabin floor and the chains or ropes to displace the fixation point in dependence on the weight force and torque applied by the compensation chain or rope to the cabin floor. The displacement cancels out the torque that would otherwise be present when a fixed off-center fixation point is employed.

The present invention concerns an elevator comprising a cabin with a cabin floor and a compensation chain being connected at a fixation point to the cabin floor, and a method to modernize and balance such an elevator.

### BACKGROUND OF THE INVENTION

Some elevator installations use a set of compensation ropes or chains to balance the weight of the traction ropes in order to keep the traction motor torque constant independently of the relative position of the cabin in the elevator shaft. One of the ends of the compensation ropes or chains set is fixed to the lower part of the counterweight and the other is fixed to the lower part of the cabin. Such elevator compensation chains are disclosed, for example, in patent documents EP 0 653 372 and U.S. Pat. No. 3,768,596.

Traditional elevator installations have one of the ends of the ropes or chains set at a fixed point on the lower part of the cabin, near the counterweight side. This fixation procedure became of common usage because, if the fixation point is at the center of the cabin, the compensation ropes or chains would hit the lower back part of the cabin when it is in the lowest part of the elevator shaft and the counterweight is in the uppermost part of the shaft, thereby damaging the ropes or the cabin.

However, this procedure of fixation of the ropes or chains set presents a shortcoming, since the fixation point is not centered and generates an unbalance on the cabin when the cabin is in the upper part of the shaft. This unbalance is the result of the off-centered force applied to the cabin by the weight of the compensation ropes or chains and produces excessive wear of the guide shoes and the guides of the elevator.

Another disadvantage of this traditional fixing procedure is the possibility that it makes travel uncomfortable for the passengers or even may menace their safety.

Patent document WO 96/06794 discloses a method and apparatus for installing and balancing an elevator car. This method for installing and balancing an elevator car situated in a hoistway, where cables attach to the car, is characterized by the following steps: providing an adjustable connector attached to the elevator car having two degrees of adjustable motion; positioning the connector in a desired location underneath the car; connecting the cables to the adjustable connector; and balancing the elevator car with an adjustable weight, which is also attached to the underside of the elevator car. The apparatus for installing and balancing an elevator car having cables attached to its underside includes an adjustable connector attached to the elevator car having two degrees of adjustable motion and an adjustable weight which attaches to the underside of the elevator car and is used to balance the car.

This method of balancing an elevator car requires, however, additional weights to be attached to the underside of the elevator car. The method is, furthermore, suited to balance the elevator car only at a pre-determined position in the elevator shaft and does not take into consideration the displacements of the elevator car in the elevator shaft. If, for example, the balancing operation is carried out when the elevator cabin is in the lowest part of the elevator shaft, the elevator cabin will no longer be balanced when it travels to the uppermost part of the elevator shaft, due to the different weight force and torque applied by the compensation chain to the elevator cabin in that position.

An object of the present invention is therefore to provide an elevator that does not exhibit the above-mentioned shortcomings. An object of the present invention is, in particular, to provide an elevator whose cabin is always balanced independently of the position of the cabin in the elevator shaft, and whose compensation rope or chain never hits the cabin, independently of the position of the cabin in the elevator shaft.

Another object of the present invention is to balance and modernize in an inexpensive, simple, easy, robust and reliable way an existing elevator, in such a way that the cabin becomes always balanced, independently of the position of the cabin in the elevator shaft, and that the compensation rope or chain never hits the cabin.

In addition, a further object of the present invention is to provide an inexpensive, simple, easy, robust and reliable apparatus, which can be easily installed and maintained on new and existing elevator installations still using a traditional compensation fixing procedure, which allows the elevator cabin to be always balanced, independently of the position of the cabin in the elevator shaft, and to be never hit by the compensation rope or chain.

### BRIEF DESCRIPTION OF THE INVENTION

An elevator, which solves these problems according to the present invention, comprises a cabin with a cabin floor and a compensation chain being connected at a fixation point to the cabin floor, wherein a displacement element is provided to displace the fixation point in dependence upon the weight force and torque applied by the compensation chain to the cabin floor.

The invention exhibits the advantage that the elevator cabin is always balanced, independently of the position of the cabin in the elevator shaft, and the compensation rope or chain never hits the cabin, independently of the position of the cabin in the elevator shaft, since the displacement element displaces the fixation point between cabin floor and compensation chain in dependence on the varying weight force and torque applied by the compensation chain to the cabin floor while the cabin travels in the elevator shaft. This positioning becomes a function of the compensation chain weight and torque, which, on the other hand, is a function of the relative position between the cabin and the counterweight.

The displacement element may comprise an elastic element, such a spring or a buffer of compressible fluid, such as oil or air, which is so configured to displace the fixation point in dependence on the weight force and torque applied by the compensation chain to the cabin floor.

This preferred embodiment exhibits the advantage that the elastic element can be directly loaded with the weight force and torque applied by the compensation chain to the cabin floor and can automatically correct the fixation point of the compensation ropes or chains set as a function of the relative position between the cabin and the counterweight of the elevator. The resulting displacement element is therefore automatic, self-regulating and self-centering. The resulting device is made of an element that changes its length as a function of the weight of the chain and the compensation system, producing an opposing elastic force to the weight of the chain of the compensation set, changes in a self-regulating way the position of the fixation point between cabin and compensation chain.

The displacement element may further comprise a cylinder, which guides a sliding piston connected to the elastic element, compensation chain being fixed to the piston. This preferred embodiment exhibits the advantage that the displacement of the fixation point between cabin and compensation chain is determined by the movement of the piston guided by the cylinder and is thus reproducible and well controllable and defined.

The end of the compensation chain can be connected to the lower part of the cabin through the piston, which slides in a guide, permitting the movement of the end of the compensation ropes or chains from the center of the cabin to the extreme lateral position as a function of the force due to the weight of the compensation chain connected to the lower part of the cabin, or, respectively, from a lateral position near the counterweight side to the cabin center of gravity, as a function of the relative position between the cabin and the counterweight.

The displacement element may be firmly fixed to the cabin floor through a structural support. This preferred embodiment exhibits the advantage that the displacement of the fixation point between cabin and compensation chain is determined by the angle set by the fixation support between cylinder and cabin floor, and is thus reproducible, well controllable and defined and suitable to be regulated.

The end of the compensation chain can be connected to the lower part of the cabin through the displacement element, which itself is fixed to the lower part of the cabin floor with a specified structural support. The fixation point of the compensation chain to the cabin floor is displaced when the elevator cabin travels from the lower part to the upper part of the elevator shaft. This preferred embodiment exhibits the advantage that the displacement of the fixation point between cabin and compensation chain and the stiffness of the displacement element are adjusted and biased to react to the changes of the weight force applied by the compensation chain while the cabin travels.

The fixation point of the compensation chain may lie in the rear part of the cabin floor at the counterweight side, when the elevator cabin is in the lower part of the elevator shaft. This preferred embodiment exhibits the advantage that the fixation point of the compensation ropes or chains is at the lower back end of the cabin near the counterweight side when the cabin is in the lower part of shaft. Contact between the cabin and the compensation chain or rope is therefore prevented.

The fixation point of the compensation chain may lie in the central part of the cabin floor close to the projection of the elevator rope fixation to the cabin frame, when the elevator cabin is in the upper part of the elevator shaft. This preferred embodiment exhibits the advantage that the elevator cabin is perfectly balanced when the cabin is in the uppermost part of the elevator shaft.

The displacement element comprises mechanical components, which set the fixation point of the compensation rope or chain assembly at the center of the cabin when the cabin is in the upper part of a shaft and near the counterweight side when the cabin is in the lower part of the shaft. The mechanical components displace the position of the end of the compensation rope or chain as a function of the weight of the compensation rope or chain, which depends on the relative position between the cabin and the counterweight. When the cabin starts to move upwards approaching the upper part of the shaft, the device automatically centers the compensation chain fixation point, reducing thus the unbalance effect produced by the weight of the compensation chain.

In another aspect of the invention, a displacement element for an elevator can be provided, which is suitable to displace the fixation point of the cabin floor of the elevator cabin to a compensation chain in dependence on the weight force and torque applied by the compensation chain to the cabin floor.

As disclosed, the invention exhibits the advantage that the displacement element is a low cost device with simple construction, which can be used in any elevator installation requiring compensation ropes or chains. The device is self-centering and corrects the fixation point of the compensation ropes or chains at the lower part of the cabin of an elevator, in order to eliminate the cabin unbalance which occurs when the compensation ropes or chains are positioned at a fixed point.

The present invention also encompasses a method to balance and/or modernize an elevator with an elevator cabin having a compensation chain fixed to the cabin floor, wherein a displacement element is inserted between the compensation chain and the cabin floor in order to displace the fixation point of the compensation chain to the cabin floor in dependence on the weight force and torque applied by the compensation chain to the cabin floor.

Such a method exhibits the advantage that new and old elevator installations can be balanced and modernized in an inexpensive, simple, easy, robust and reliable way by the introduction of a displacement element of low cost and with a simple construction, which can be used in any elevator installation requiring compensation ropes or chains. The device method the fixation point of the compensation ropes or chains set at the lower part of the cabin of an elevator in order to eliminate cabin unbalance which occurs when the compensation ropes or chains are positioned at a fixed point.

### BRIEF DESCRIPTION OF THE DRAWINGS

For a more complete description of the present invention and for further objects and advantages thereof, reference is made to the following description, taken in conjunction with the accompanying drawings, in which:

FIG. 1 is a representation of an elevator installation according to the state of the art, where the cabin is at its lowest position and the compensation chain is fixed according to the traditional procedure at a fixed point in the lower part of the cabin near the counterweight side;

FIG. 2 represents the same installation shown in FIG. 1 according to the state of the art, when the cabin is in its highest position;

FIG. 3 is a representation of an elevator installation with a displacement element according to the present invention installed under the cabin and with the cabin in its lowest position;

FIG. 4 represents the same installation as shown in FIG. 3 with a displacement element according to the present invention, when the cabin is in its highest position;

FIG. 5 shows an embodiment of the displacement element according to the present invention in which a spring is used; and

FIG. 6 shows an alternative embodiment of the displacement element according to the present invention, in which an oil or air buffer is used.

### DETAILED DESCRIPTION OF THE INVENTION

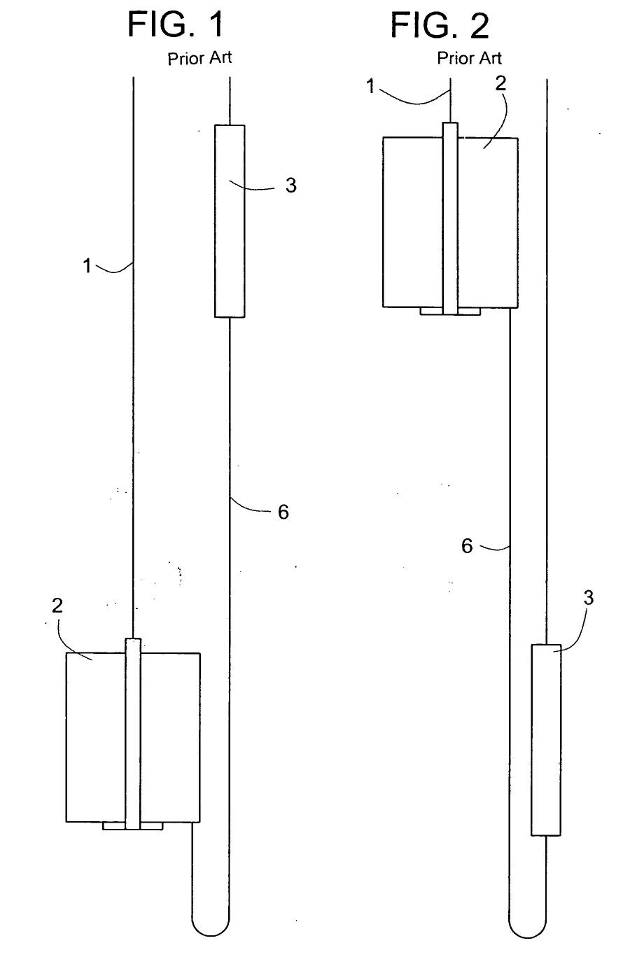

FIG. 1 shows an elevator according to the state of the art with an elevator cabin 2 suspended by an elevator rope 1. A counterweight 3 counterbalances the weight of the cabin 2 and is connected to the bottom of the cabin 2 through a compensation chain 6.

In FIG. 1 it can be observed that when the cabin 2 is in the lowest position in the elevator shaft, the compensation rope or chain 6 fixed with the traditional procedure does not cause any unbalance, since the force on the cabin due to the compensation chain's weight is negligible.

On the other hand, FIG. 2 shows the same elevator installation of FIG. 1 according to the state of the art when the cabin 2 travels to the uppermost position in the elevator shaft. It can be observed that when the cabin 2 is in the highest position in the shaft, the compensation chain 6 fixed with the traditional procedure causes a large unbalance on the cabin 2: the force resulting from the weight of the compensation chain 6 is quite considerable and is applied displaced from the cabin center of gravity.

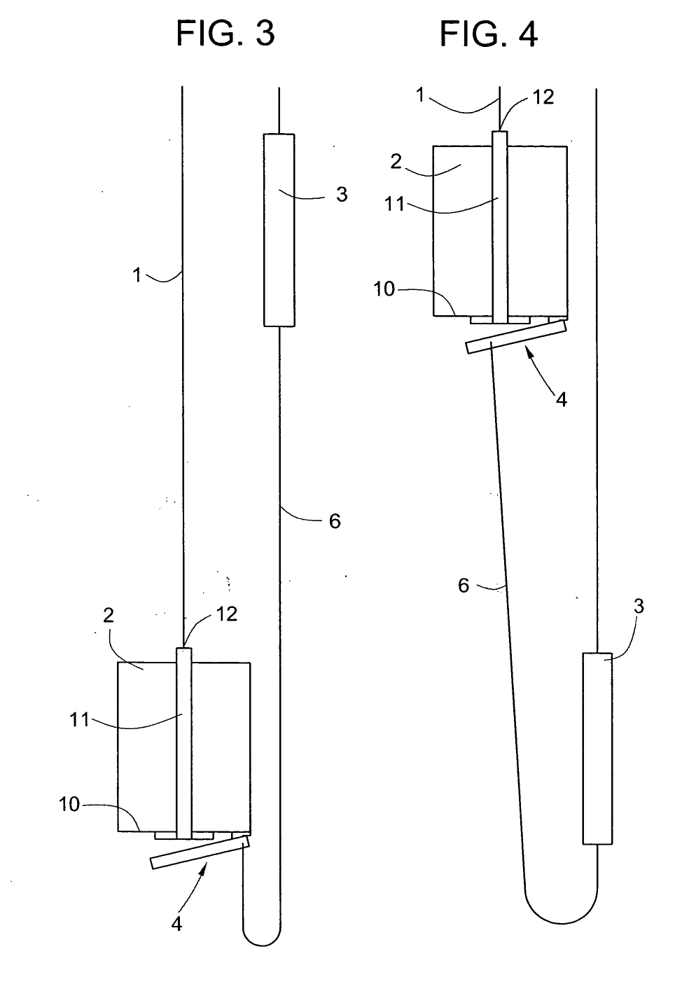

In FIG. 3, according to a preferred embodiment of the present invention, one end of the compensation chain 6 is fixed to the lowest part of the counterweight 3 and the other end is fixed to the cabin floor 10 by means of a displacement element 4, which displaces the fixation point between cabin floor 10 and compensation chain 6 in dependence on the weight force and torque applied by the compensation chain 6 to the cabin floor 10.

In FIG. 3 the elevator cabin 2 is situated in the lowest part of the elevator shaft. Since the weight force and torque applied by the compensation chain 6 to the cabin 2 is negligible, the displacement element 4 sets the fixation point of the compensation chain 6 to the cabin floor 10 in the rear part of the cabin floor 10 at the counterweight side.

If the elevator cabin 2 travels from the lower part to the upper part of the elevator shaft, the weight force and torque applied by the compensation chain 6 to the cabin 2 increases and displacement element 4 displaces the fixation point between cabin floor 10 and compensation chain 6 in dependence on the weight force and torque applied by the compensation chain 6 to the cabin floor 10. Accordingly, the fixation point is moved towards the central part of the cabin floor.

FIG. 4 shows the same elevator installation of FIG. 3 according to a preferred embodiment of the present invention when the cabin 2 travels to the uppermost position in the elevator shaft. Since the weight force and torque applied by the compensation chain 6 to the cabin 2 is considerable, the displacement element 4 sets the fixation point of the compensation chain 6 at the central part of the cabin floor 10 in a position close to the projection of the elevator rope fixation point 12 to the cabin frame 11. The rope fixation 12 to the cabin frame 11 in general lies on the vertical passing through the center of gravity of the elevator cabin 2, in order to avoid any unbalancing torque. In such a condition, the elevator cabin 2 is perfectly balanced.

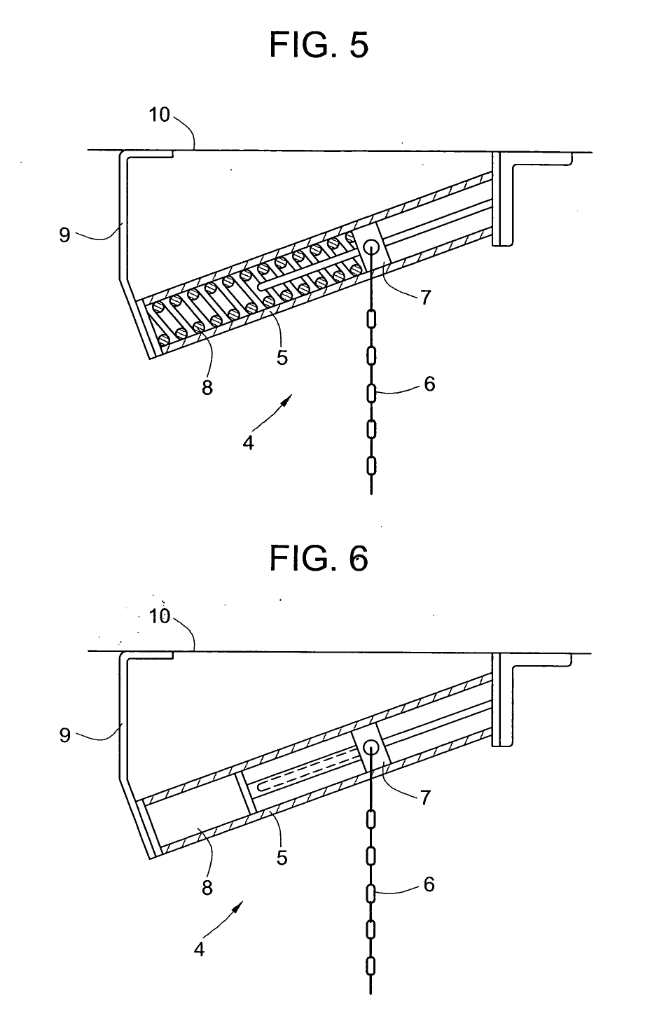

The displacement element 4 can be realized in various embodiments. FIG. 5 discloses a preferred embodiment for the displacement element 4, which is firmly fixed under the cabin floor 10 with a structural support 9.

The displacement element 4 comprises an elastic element or spring 8, which acts on the compensation chain fixing piston 7 holding the compensating rope or chain 6 and sliding in a cylinder 5 arranged in an oblique position in respect to the cabin floor 10.

The elastic element 8 in the form of a spring of the displacement element is so configured to displace the fixation point between cabin floor 10 and compensation chain 6 in dependence on the weight force and torque applied by the compensation chain 6 to the cabin floor 10. The displacement element 4 comprises the cylinder 5, which guides the sliding piston 7 connected to the elastic element 8. The compensation chain 6 is fixed to the piston 7.

The fixation point of the compensation chain 6 to the cabin floor 10 is, in this case, the location of the piston 7, to which the compensation chain 6 is attached. When the weight force or torque applied by the compensation chain 6 increases, the force exerted by the piston 7 on the elastic element 8 increases. The elastic element 8 is therefore compressed elastically along the direction set by the cylinder 5 and reversibly moves the piston 7 and thus the fixation point between cabin floor 10 and compensation chain 6 towards the central part of the cabin floor 10, as required to solve the problem considered by the present invention.

The extent of the displacement of the fixation point between cabin floor 10 and compensation chain 6 can be set up and regulated through the rigidity of the displacement element 4. Said rigidity can be changed by modifying the elastic modulus of the elastic element 8 or by changing the angle between the cylinder 5 and the cabin floor 10. The smaller the angle between cylinder 5 and cabin floor 10, the higher the apparent stiffness of the displacement element 4.

FIG. 6 shows an alternative embodiment for the displacement element 4, whereby the elastic element 8 is not a spring, but rather a buffer of compressible fluid, such as oil or air.

The position of the piston 7 and of the end of the compensating chain or rope 6 fixed to the piston is the result of two factors, i.e. the weight of the compensating chain 6, which is a function of the relative position between the cabin 2 and the counterweight 3 and the linear density of the chain 6; and the opposing force produced by the spring or buffer 8. Therefore, as the cabin 2 moves from the lower position in the shaft to the upper positions, the force produced by the weight of the compensation chain 6 increases, overcoming the force produced by the elastic element 8 and thereby moving the piston 7 towards the center of gravity of the cabin 2.

On the other hand, as the cabin 2 moves from the upper position to the lower positions, the length of the compensation chains 6 is reduced and thus the resultant force from its weight is overcome by the force produced by the elastic element 8, making the piston 7 to move towards the counterweight 3.

The movement of the piston 7 can be further understood through FIGS. 3 and 4. In its initial position (FIG. 3), the piston 7 of the displacement element 4 is near the side of the cabin for counterweight 3. As explained previously, such configuration is required to avoid the chain 6 touching the back of the cabin 2 and damaging the cabin. In this case, the unbalance caused by the application of the weight force of the compensation chain 6 at a point offset from the projection of the center of mass of the cabin is negligible, since the effective weight force applied is negligible, as a result of the minimal length of the supported portion of chain 6.

As the cabin 2 moves upwards, the piston 7 moves, as described, to the final position shown in FIG. 4, which is a position very close to the vertical line passing through the cabin center of gravity. The rope fixation 12 to the cabin frame 11 thus lies in general on a vertical line passing through the center of gravity of the elevator cabin 2 as well, in order to avoid any unbalancing torque. In this situation, even a chain force of considerable magnitude would not cause any unbalance on the cabin 2, since the force is applied on the center of the gravity line of the cabin.

Despite the fact that only some possible constructive embodiments for the displacement elements are described and illustrated herein, the inventive concept can be applied to other configurations for the displacement element. A displacement element such as described herein could also be used advantageously for any other chain, rope or cable suspended under the elevator cabin, such as for example a traveling flex.

A displacement element such as the one described in the above description is well suited to be installed in either a new or old elevator installations, in order to balance and modernize it, so that the cabin is always balanced, independently of the position of the cabin in the elevator shaft, and the compensation rope or chain never hits a part of the cabin, independently of the position of the cabin in the elevator shaft.

It is enough to insert the displacement element 4 between the compensation chain and the cabin floor, in order to displace the fixation point of the compensation chain to the cabin floor in dependence on the weight force and torque applied by the compensation chain to the cabin floor.

Such a balancing and modernization method is very inexpensive, simple, easy, robust and reliable, since only one operation is required and the displacement element comprises few simple mechanical components.

I claim:

1. An elevator, comprising a cabin with a cabin floor and at least one compensation chain or rope connected at a fixation point to the cabin floor, characterized in that a displacement element is provided to displace said fixation point in dependence on a weight force and torque applied by the at least one compensation chain or rope to the cabin floor.

2. The elevator according to claim 1, wherein the displacement element comprises an elastic element so configured to displace the fixation point in dependence on the weight force and torque applied by the at least one compensation chain or rope to the cabin floor.

3. The elevator according to claim 2, wherein the displacement element further a sliding piston and a cylinder for guiding the sliding piston, the sliding piston being connected to the elastic element, the at least one compensation chain or rope being fixed to the piston.

4. The elevator according to claim 1, 2 or 3, wherein the displacement element is firmly fixed to the cabin floor through a structural support.

5. The elevator according to claim 1, 2 or 3, wherein the displacement element is so configured as to displace the fixation point of the at least one compensation chain or rope when the elevator cabin travels from a lower part to an upper part of an elevator shaft for the elevator.

6. The elevator according to claim 1, 2 or 3, wherein the fixation point lies in a rear part of the cabin floor at a counterweight side when the elevator cabin is in a lower part of an elevator shaft for the elevator.

7. The elevator according to claim 1, 2 or 3, wherein the fixation point lies in a central part of the cabin floor proximate a projection of an elevator rope fixation to a frame of the cabin when the elevator cabin is in an upper part of an elevator shaft for the elevator.

8. The elevator according to claim 2, wherein the elastic element is chosen form a group consisting of a spring and a buffer of a compressible fluid.

9. A displacement element for an elevator comprising a cabin with a cabin floor and at least one compensation chain or rope connected at a fixation point to the cabin floor, adapted and constructed to displace the fixation point of the cabin floor to the at least one compensation chain or rope in dependence on the weight force and torque applied by the compensation chain or rope to the cabin floor.

10. A method to balance and/or modernize an elevator having an elevator cabin with at least one compensation chain or rope fixed to a cabin floor, comprising the steps of inserting a displacement element between the at least one compensation chain or rope and the cabin floor, and displacing a fixation point of the at least one compensation chain or rope to the displacement element in dependence on a weight force and torque applied by the at least one compensation chain or rope to the cabin floor to minimize torque generated by the at least one compensation chain or rope upon the elevator cabin.
